(19) United States
(12) Patent Application Publication
(10) Pub. No.: US 2020/0111376 A1
(43) Pub. Date: Apr. 9, 2020

(54) AUGMENTED REALITY TRAINING DEVICES AND METHODS

(71) Applicant: KINOTEK LLC, Portland, ME (US)

(72) Inventors: William Patrick Breeding, Orono, ME (US); David Gregg Holomakoff, Portland, ME (US)

(21) Appl. No.: 16/594,616

(22) Filed: Oct. 7, 2019

Related U.S. Application Data
(60) Provisional application No. 62/741,213, filed on Oct. 4, 2018.

(51) Int. Cl. G09B 5/02; G06T 11/00

(52) U.S. Cl. CPC G09B 5/02; G06T 2200/24; G06T 11/00

(57) ABSTRACT

Methods and devices for completing a series of tasks using augmented reality (AR) features are described. In the disclosed methods, live video of a tangible target (for example, a human, manikin, animal, plant, or inanimate object), is captured and displayed, one or more graphic indicators specific to a first task are generated (using a processing device) and displayed on the live video. A position of a tangible object (e.g., an instrument controlled by user) relative to a first location on the target is detected and the processing device determines whether the action of the tangible object completes the first task. Once the first task has been determined to be complete, subsequent tasks and associated graphic indicators are generated and displayed to prompt the user to perform additional actions with respect to the target.

### CROSS-REFERENCE TO RELATED APPLICATIONS

This patent application claims priority from U.S. Provisional Patent Application No. 62/741,213 filed Oct. 4, 2018 and is herein incorporated by reference in its entirety.

### FIELD

The present disclosure relates to computing-based training utilizing guided simulation and, more specifically, to augmented reality simulation and instructional software for professional and educational training purposes, including, but not limited to: medical, human to human, human to animal, human to plant, and/or educational training.

### BACKGROUND

Visual learning has been utilized by humans for thousands of years, being a major function of how motor function is improved in certain tasks over time, typically performed in a “trial and error” fashion. As humans have progressed, many jobs requiring the development of motor function lack the luxury to do so. Causal factors to this inconvenience include cost, accessibility, and safety of such educational experiences.

Such barriers have, and always will, present themselves as downfalls that look to technology development and innovation to be overcome. Many proposed solutions to trial and error training consistently fail to acknowledge cost and accessibility, only succeeding in creating a safer environment. Additionally, there is a constant compromise between effectiveness of the training situation and cost/accessibility. Simulation tools such as flight simulators or medical simulation manikins are normally combinations of expensive hardware that are large and relatively non-portable. Additionally, these tools are only fully effective with instructors physically present, an expert that serves to moderate the trial and error experience, offering seasoned but subjective expertise. The accessibility of a high fidelity simulation tool and instructor is rare and thus unable to educate the majority of the population. Augmented reality (AR) is a relatively new technology that, with the use of practically any computer and connected camera, can project a 2D or 3D image into a real-life space being perceived by the camera. AR technology can currently be found in some smartphones, tablets, projection glasses, and AR headsets. AR is one of the fastest growing technical fields in the world, estimated to have a market value of over $200 billion by the year 2022.

### SUMMARY

Virtual experiences present unique and valuable opportunities for training and diagnostic purposes. As described below in detail, the presently disclosed methods can be implemented using interfaces such as personal computers (PCs), mobile laptops, smartphones, tablets, and virtual reality headsets. Using these interfaces, accessible learning can be achieved while also creating a safe and reasonably cost-effective environment for the user. Additionally, the accuracy and interactive features provided by these devices and the presently disclosed methods can connect those who may need timely or immediate care with specialists in the relevant medical profession. The large void in learning that is missing from the currently available tools includes physical and sensory feedback that one gains from an action or motor skill performed regularly with expert supervision.

The field of augmented reality, a unique incarnation of virtual reality, is rapidly growing and possesses seemingly endless applications that are limited only by the human imagination. The ability to augment the real world with three dimensional and/or two-dimensional virtual images is a powerful tool that can be critical in many educational and simulation scenarios. Not only can it increase the fidelity of low fidelity instructional tools/situations in the real world, but it can do so without the physical presence of an instructor.

Instructional software, sports, and/or games requiring performance of physical actions, and acknowledgment of those actions in real time, can be used to increase the effectiveness and accessibility of training routines. In some such instances, all that is required is a computing processor, camera, and a screen. The proposed technology and methods provide a safe, cost-effective, widely accessible learning, and educationally effective experience, combining the cost-effective, accessible, nature of outdated virtual learning with the tangible stimuli and emotional response of real-world trial and error.

The proposed disclosure possesses multiple improvements over existing methods of physically simulated and virtual learning. For example, leveraging the technology of augmented reality, virtually educating students and workers on where and how to perform physical actions in real physical space in real time and testing/examining said actions within seconds combines the best attributes of the majority of the most effective learning techniques while eliminating their individual flaws. The result is higher learning in a more economical and psychomotor way.

In some aspects, the disclosed methods can be used as an educational enhancement, adding greater value to existing medical training practices. As discussed in more detail below, the disclosed methods use a processing device (such as a phone or computer) to virtually project a graphic image, object or animation (generally referred to as a “graphic indicator”) into an augmented reality overlay of the visible real-world (typically through a camera attached to a processing device). To do this, the software may reference markers, which may be virtual or tangible/physical objects, images or animations, to display the graphic indicator(s) in specific locations on the real-world image or video. Image processing and marker detection algorithms can be used to detect the presence, interaction of, or lack of a distinct object, image or animation. As will be appreciated upon consideration of the present disclosure, the physical performance of the user can be impartially evaluated using the disclosed methods.

The application of this augmented reality technology is contemplated for use as a medical simulator but may have numerous other applications. For example, in some cases, medical trainees may use a smartphone or computer to view the ‘real-world’ on their screen (through the camera) and project augmented reality objects, images or animation into it, in specific locations onto the real-world as viewed through the screen of the device. The virtual objects projected may be anatomical or physiological images/objects, and/or instructions to walk trainees through a clinical situation. The virtual objects may be displayed on the device's screen or projected onto a medical training manikin, patient, patient actor, friend, or family member, to add context and educational density to the training experience. Using feedback (in the form of geospatial, spatial image locations, presence, interaction or lack of object(s)) provided by the software, the user may be prompted to perform typical medical assessment tasks, receive information as to whether or not they completed the task correctly, and be walked through, step by step, the processes of correct medical assessments.

In select embodiments, 3D or 2D objects, images or animations (such as organs, muscles, vasculature, and other subsystems of anatomy and physiology) may be projected onto the previously described target (e.g., patient or simulated patient) in correct anatomical location of the physical object. These anatomical projections may be changed or otherwise manipulated to show various pathological or healthy representations of that anatomical system. An interactive user interface or use of recognized physical/virtual objects can prompt a change or alteration in virtual objects, images or animations. For example, a user could elect to administer a treatment to a virtually projected pathology, and watch the virtual object change over time in response to the treatment.

It should be understood that the proposed AR technology does not solely apply to medical education applications. In fact, companies may look to this technology as an important way to create AR games and other mobile-based educational applications (apps). Mobile apps that will educate and walk the user through specific human interactions or gamify human to human interaction in real-time are contemplated as useful applications for the presently disclosed methods and techniques. These future applications are expected to increase in number as mobile AR advances, adding to the potential value of the technology. The presently disclosed methods and techniques are set forth in the following sections and accompanying figures in greater detail.

### BRIEF DESCRIPTION OF THE DRAWINGS

FIG. 1 illustrates an exemplary method for completing a series of tasks using graphic indicators, in accordance with some embodiments of the subject disclosure.

FIG. 2 shows a photograph of a smartphone displaying a view of a software application configured in accordance with some embodiments of the subject disclosure.

FIGS. 3A-3D show photographs of a process used to configure a software application in accordance with embodiments of the subject disclosure.

FIG. 4A-4D show photographs of a process used to configure a software application in accordance with embodiments of the subject disclosure.

FIG. 5 shows an exemplary computer system that may be used in connection with some example embodiments of the subject disclosure.

### DETAILED DESCRIPTION

Methods and techniques are described herein relating to transitory computer-readable media for augmented reality, simulation-based training. Augmented reality is a particular incarnation of virtual reality and can greatly advance the degree of user motor skills, knowledge base, equipment fidelity, environment fidelity, and/or psychological fidelity when used in accordance with the presently disclosed methods and devices. As will be more thoroughly described below, the disclosed methods can be used for simulation purposes in training exercises, with some embodiments directed to decreasing the cost and improving portability of simulation systems and learning processes.

As will be appreciated by those skilled in the art upon consideration of the subject disclosure, an augmented reality environment, as discussed herein, refers to the perception of a user of their real, physical, tangible environment with the addition of virtual, projected, two or three-dimensional objects displayed in that environment. Integral to the concept of an augmented reality environment is the feature of virtual objects perceived as existing in the real space as if they were real/tangible objects. Additionally, virtual objects (otherwise referred to as “graphic indicators” herein) may be visible to a user from a variety of perspectives, allowing the user to visually perceive the virtual objects from a multitude of perspectives and angles. In harnessing this technology for training, the methods described herein can enable virtual embodiments of nearly any positional marker(s) in an infinite amount of locations. Most notably, the presently disclosed methods show promise when used in connection with interactive physical objects, such as a medical simulation manikin, a human manikin, an animal manikin, and both living and non-living organisms (e.g., humans, animals, plants, and/or insects).

In some particular embodiments, the user is taking part in a human to human physical interaction, specifically one of medical consequence. As previously stated, the disclosed methods need not be limited to medical uses. The disclosed methods can be configured for human to human interactions, human to animal interactions, human to plant interactions, human to manikin (medical or non-medical) interactions, or interactions with any other organism that require instructive interaction.

In some embodiments, a user will locate a target human (patient in this particular embodiment) with a camera communicating with a processing unit. The processing unit can be but is not necessarily: stationary, held by the user, or worn by the user to help secure it to the user's body to keep it in a usable position. The processor is configured to send signal to a viewing window (such as a typical LCD screen) or a projecting unit capable of hologram projection, projection onto a glass surface, projecting into the user's eye, or otherwise typical methods used in the art of augmented reality and mixed reality glasses and headsets (wearables). This viewing window or projection is where the user gathers information. The viewing window or projecting unit can be, but is not necessarily: stationary, held by the user, or worn by the user to help secure it to the user's body to keep it in a usable position.

The camera and processing device work together to identify the target human (patient) and their position in real space. It can do this using modern methods of AR detection as well as other techniques that may be known by those skilled in the art. Exemplary methods of object detection include but are not limited to: physical markers, two-dimensional or three-dimensional markers that can be viewed by the camera, electromagnetic marker(s), displaying location, orientation, and identity data to the processor, color contrast detection, geospatial and spatial mapping done by the processor using the camera, and any other suitable methods known in the art.

The processing device can augment a single virtual indicator or multiple virtual indicators (i.e., graphic indicators) onto the human (patient) located in the physical space. The locations of these indicators have significance to the end goal of the software, whether the end goal is instruction, gaining knowledge, performing an action of importance, a competitive sport or game, or anything else the developer deems fit. These indicators will typically require, but do not necessarily need interaction by the user. Interaction can be forgone, for example, when the user requires the information of specified target positions on the target human (patient). In the case of a medical embodiment, example locations provided by the virtual indicators can be, but are not limited to: locations of medical importance such as landmarks for medical assessment, placement locations for medical tools, and the locations of organs and tissues.

If a user wishes to interact with virtual indicators to learn skill, practice skill, or play a game, the presently disclosed technology is capable of identifying the physical interaction of the user by locating the physical position of the user and/or a tool being used by the user. From now on this will be called the “tangible object.” When the tangible object occupies a location in two or three-dimensional space within a specified distance from the virtual indicator (using one or all of Cartesian, cylindrical, and/or spherical coordinates). This distance is indicated by the developer, however, in some embodiments, the distance may be selected so that the simulation, exercise, sport, or game is a true assistant for gaining skill and knowledge when applied to real-world scenarios. This is especially true in applications where the user is running through a scenario for the first time, such as a possible medical diagnosis. The location of the tangible object and distance away from the virtual indicator is registered and identified in real time and constantly updated using the processor and camera. The time required for the position of the tangible object to be located within the distance threshold of the virtual indicator can vary greatly and is at the discretion of the developer. In some particular embodiments, 3-5 seconds would be an example amount of time needed for actions such palpating (touching) muscles and auscultating (listening to) the heart or lungs.

Once the user completes the task of physically interacting with the virtual indicator and/or patient, this is recognized and a new virtual indicator or multiple new virtual indicators will be augmented onto the patient. If the designed program has finished, this will result in no virtual indicators being present. During any of these possibilities, a positive reinforcement message may or may not displayed within the user's method of viewing the AR (The viewing window or projection). If more virtual indicators become present, the previously described steps can continue and repeat until the training, process, exam, sport or game is completed by the user.

It should be noted that this particular scenario is but one of many embodiments of the proposed inventive subject matter. Other embodiments might include: telemedical applications or projecting an indicator onto an object, such as a tree, to indicate information or prompt further action, such as where to cut. Another example may be projecting indicators on vegetables, fruit, dead leaves and branches, and other substances from plants that need to be picked, projecting an indicator on a static or moving insect, projecting indicators onto a cadaver for medical examination or education, projecting an indicator onto an animal that is in need of care, and projecting an indicator onto another human for recreational, sport, and gaming purposes. Further details of the presently disclosed methods are discussed in the following section.

### Exemplary Methods

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

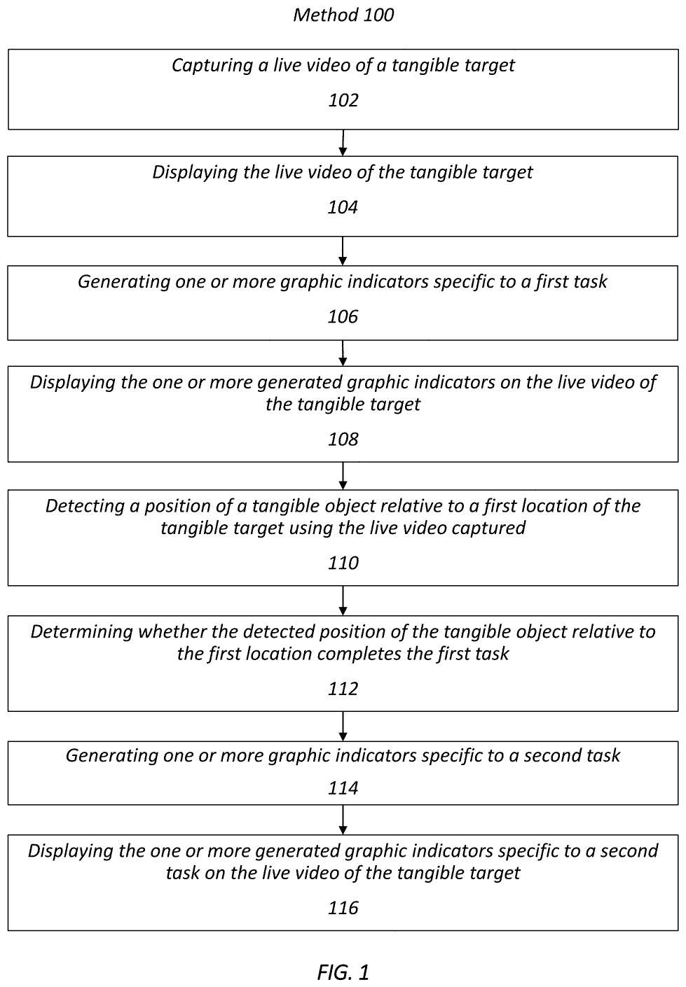

FIG. 1 illustrates an exemplary method 100 of engaging with the presently disclosed augmented reality technology. In particular, method 100 is directed to a method for completing a series of tasks using graphic indicators (otherwise generally referred to herein as “markers” generated by a machine or device. Method 100 of FIG. 1 illustrates generalized features that may, as explained below in detail, be utilized for numerous different tasks in a variety of settings.

As shown in FIG. 1, method 100 includes capturing a live video of a tangible target (Block 102). Any suitable instrumentation may be used to capture the live video of the tangible target. For example, in some embodiments, a mobile computing device, such as a smartphone, AR headset, tablet, or other suitable device may be used. Similarly, in these and other embodiments, the tangible target may be living or an inanimate object. In some embodiments, a human or animal patient may be the tangible target, whereas in other embodiments, a manikin, plant, organism, or other object may be the tangible target.

Method 100 of FIG. 1 continues with displaying the live video of the tangible target (Block 104). The live video may be displayed on a screen of an electronic device, in some embodiments. The electronic device may be a mobile computing device, such as a tablet or smartphone. However, in other embodiments, the electronic device may simply be a screen in communication with a camera, processing device, and/or memory. In select embodiments, the live video of the tangible target may be displayed on a heads-up display (HUD). The live video may be displayed in color or in black and white, as desired.

Method 100 of FIG. 1 continues with generating one or more graphic indicators specific to a first task (Block 106). As will be appreciated, the one or more graphic indicators may be generated using a processor in communication with the machine capturing and/or displaying the live video or a different device. The first task may be directed to moving a tangible object (e.g., a medical instrument) in a predetermined way relative to a first location of the tangible target. For example, if a user is participating in a simulation to assess a patient's vital signs, the first task may be to check the patient's heart rate. Thus, the first location may be over the patient's chest. In some embodiments, the generated graphic indicators can appear as images related to the first task to be performed. For example, in embodiments in which the first task is to measure the heart rate of a target, the graphic indicator(s) may appear as a heart-shaped object.

The graphic indicators or markers generated by the disclosed methods may take any desired form. For example, graphic indicators may appear as a physical (or virtual, as the case may be) object, an image, animation, or component thereof. The graphic indicators can appear in any suitable size, color, shape, dimension (for example, in 2D or 3D). In some embodiments, the graphic indicators appear in a static state, whereas in other embodiments, the graphic indicators appear in a kinetic state.

Method 100 of FIG. 1 continues with displaying the one or more generated graphic indicators on the live video of the tangible target (Block 108). The graphic indicators may appear in any desired manner. For example, if the first task is to check the patient's heart rate, the graphic indicator of a heart may be displayed in a position on the target's chest in the live video. In some embodiments, the one or more graphic indicators may be displayed in a constant position relative to the tangible target. In some such embodiments, if the target moves in the displayed live video, the one or more graphic indicators would also be shown as moving in the displayed live video.

In some embodiments, the one or more generated graphic indicators may have fixed dimensions or may change dimensions with variables such as time and/or location. This concept of graphic indicator adjustment relative to the position or perception of position of the target relative to the user, where all forms of distinguishable features are variable, could include size, rotation, orientation, stretching, warping, coloration, discoloration, and/or texture, in some embodiments. For example, in embodiments in which the one or more graphic indicators change dimensions, a graphic indicator appearing as a heart may alternate between larger and smaller dimensions to appear as beating. In these and other embodiments, the graphic indicators may increase in size when the frame is moved toward the tangible target. In other words, when a user brings the device capturing the live video of the tangible target toward the tangible target, the graphic indicators generated may appear larger and vice versa.

Method 100 of FIG. 1 continues with detecting a position of a tangible object relative to the first location of the tangible target using the live video captured (Block 110). It should be understood that any type of tangible object may be used in the disclosed method. For example, a user's hand may be used as a tangible object. In other embodiments, an instrument controlled by a user, such as a pen, stethoscope, thermometer, blood pressure cuff, tongue depressor, reflex hammer, tuning fork, IV needle, sensory needle, sensory cotton, ECG lead, flashlight, or other instrument, may alternatively be used as a tangible object. As described below, the movement of the tangible object relative to the identified first location is used to determine whether the specified first task has been completed.

In some embodiments, the position of the tangible object relative to the first location of the tangible target is detected using live video from a camera within a mobile computing device. In these and other embodiments, the mobile computing device may also include a visual interface, such as a screen, that displays the live video of the tangible target.

Method 100 of FIG. 1 continues with determining whether the detected position of the tangible object relative to the first location of the tangible target completes the first task (Block 112). In some embodiments, determining whether the detected position, plurality of positions, and/or movement patterns of the detected object(s) relative to the first location completes the first task is accomplished using a processor and an algorithm stored in a memory device in communication with the processor. In some such embodiments, time, location and/or movement patterns are some of the variables used in the determination of success criteria for determining whether the first task has been completed (i.e., triggering an event). In some embodiments, the one or more generated graphic indicators may continue to be displayed on the live video of the tangible target until the first task is determined to be complete. Additionally, the live video can service as an interactive interface for the user or a third party to dictate triggering of a successful or unsuccessful performance of the designated task For example, a student may be performing an assessment task in real time, while receiving instruction from a third party such as an instructor, where the third party has the ability to remain in a graphic indicator display phase, or in a transition phase between task completion and subsequent prompt, to allow for education and reflection on a particular task.

In select embodiments, the method may further include displaying text relevant to the detected position of the tangible object relative to the first location of the tangible target. The text displayed might include information, instructions, additional graphic indicators and/or recommendations regarding the detected movement. In this manner, the disclosed methods may provide automated feedback to a user depending on the user's movements and performance of the task at hand.

Method 100 of FIG. 1 continues with generating one or more graphic indicators specific to a second task (Block 114). In some embodiments, generating one or more graphic indicators specific to a second task may be performed after the first task has been determined to be complete. In some embodiments, the one or more graphic indicators specific to the second task are distinct from the one or more graphic indicators specific to the first task. However, in other embodiments, the graphic indicator(s) specific to the second task may be the same as the graphic indicator(s) specific to the first task. In some embodiments, the second task may be directed to moving the tangible object (either the same tangible object used to complete the first task or a different tangible object) in a predetermined way relative to a second location of the tangible target. For example, in a program in which the user is checking a patient's vitals, a second task might include measuring the patient's blood pressure. In some such embodiments, the generated graphic indicator might be a blood pressure cuff.

Method 100 of FIG. 1 also includes displaying the one or more generated graphic indicators specific to the second task on the live video of the tangible target (Block 116). The graphic indicator(s) specific to the second task may be displayed on or near the second location of the tangible target, in some embodiments. For example, if the second task is to take a patient's blood pressure and a graphic indicator of a blood pressure cuff is generated, the blood pressure cuff may be displayed on or near a patient's arm in the displayed live video.

Method 100 may optionally continue with determining a position of the tangible object (for example, a blood pressure cuff) relative to the second location of the target (e.g., the patient's upper arm). Techniques previously described with respect to Block 110 may be used to detect the position of the tangible object. Similarly to Block 114, the detected position of the tangible object relative to the second location can be used to determine whether the second task has been completed.

In some embodiments, method 100 may continue with subsequent tasks (for example, a third task, fourth task, fifth task, etc.). In some such embodiments, one or more graphic indicators specific to the task are displayed, the position of a tangible object in relation to a specific location on the tangible target is detected, and then whether or not the task at hand has been completed is determined. Numerous configurations and variations of the presently disclosed methods are possible and contemplated herein.

### Development Efforts

Embodiments of the presently disclosed methods have been reduced to practice. An overview of techniques that have been used to practice some of the presently disclosed methods is provided in the following paragraphs.

Application software (specifically for a mobile application or web application) was created and the application included three main views: a main menu, an AR view, and an option view. The main menu was intended to introduce a user to the application (app) and included only one button, which allowed the user to ‘Start Simulation”. When the ‘Start Simulation’ option was selected, the interface navigated to the AR view, where the simulation/lesson would begin.

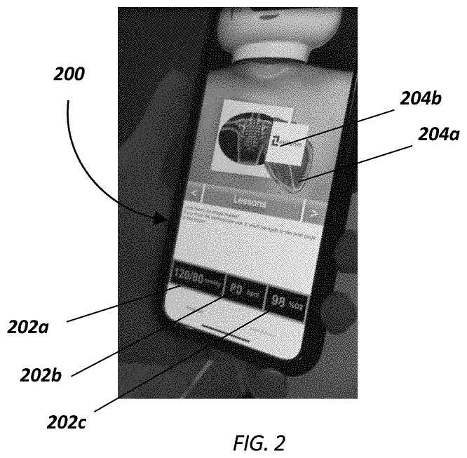

FIG. 2 shows a photo of a smartphone 200 displaying the AR view of the app. As shown in FIG. 2, the app provides an overlay of various graphic indicators onto the camera's view of view display, such as blood pressure 202a, heart rate 202b, and percent visible oxygen 202c. In some embodiments, the AR view mode includes the following five primary sections of the interface: (1) a camera field of view display, in which a user can view whatever is within the frame of the camera, as well as AR overlays of information, instructions, and/or anatomy. FIG. 2 shows a cross-section of an animated anatomically accurately located beating heart 204a, with the Zephyrus logo on top 204b that is used as a guide for stethoscope placement, discussed more in following sections; (2) a viewing mode selection and event sequence buttons, which use forward/backward buttons to progress through scenarios or view history/sequence of all events in the lesson. In some embodiments, when the lesson button is tapped, the lower section will vertically expand to reveal the text box; (3) a variable text box display that can provide information, instructions, patient status and/or any other written materials to communicate to the user; (4) vital sign indicators that depict patient information relevant to the lesson, including blood pressure, heart rate and pulse ox. These are completely variable and can change in response to student intervention/performance, and in many cases can be included in the sequence of lesson events to represent dynamic patient status; and (5) tabbed view selector (shown on the bottom of the screen in FIG. 2), which allows the user to navigate between the AR view and other view, such as Options view.

Once accessed, the Options view provides options for students to view what lesson they are currently following, and select between a library of pre-uploaded lessons. The development of this application involved the development of a trainee heads-up display (HUD) to receive information and instructions pertaining to a particular medical scenario.

The lesson information may be loaded into an iOS application via JSON files, where each lesson is contained within a single file and the application can include as many or as few JSON files (i.e. Lessons) as the administrator desires. This is incredibly advantageous from a storage perspective, as JSON files are similar to simple text files in size but do require downloading/importing the lessons into the app prior to attempting to run a lesson.

The files for each lesson may be structured quite simply using a hierarchy of commands for display features within each event (for example, anything about the display, displayed AR anatomy, text, etc, can be changed in each event). Based on whether the student's detected action meets certain criteria, an event, or stepNumber, can include feedback to the user and be automatically triggered by the criteria being met, providing a trainee with real-time, dynamic assessment feedback.

During development, finding a reliable way to display images, text, and animations in AR was of special importance since providing AR features with high resolution and accuracy will be critical to many applications of this technology, such as uses in the medical profession. As described below in detail, small deviations in three-dimensional size and location between the virtual renderings and the actual physical locations of objects were able to be achieved, along with minimized lag, all without requiring significant processing speed. To accomplish this, a spatial mapping method was employed that used physical images (stickers) as markers that when recognized by the software to set a reference point (or anchor) for Apple's AR suite to recognize spatial location relative to that marker. Therefore, if a marker located in a known, specific location relative to a target was used, the location to the display anatomy could be determined using coordinates a specific distance away from the marker.

Furthermore, with recent advancements made in Apple's ARkit, a spatial map was created based on marker coordinates. The coordinate system was ‘locked’ in, and subsequently the markers were removed while retaining the mapped system. Therefore, the markers used could simply serve to calibrate the system pre-simulation, but not remain present the full extent of the lesson where they might detract from the realism of the scenario.

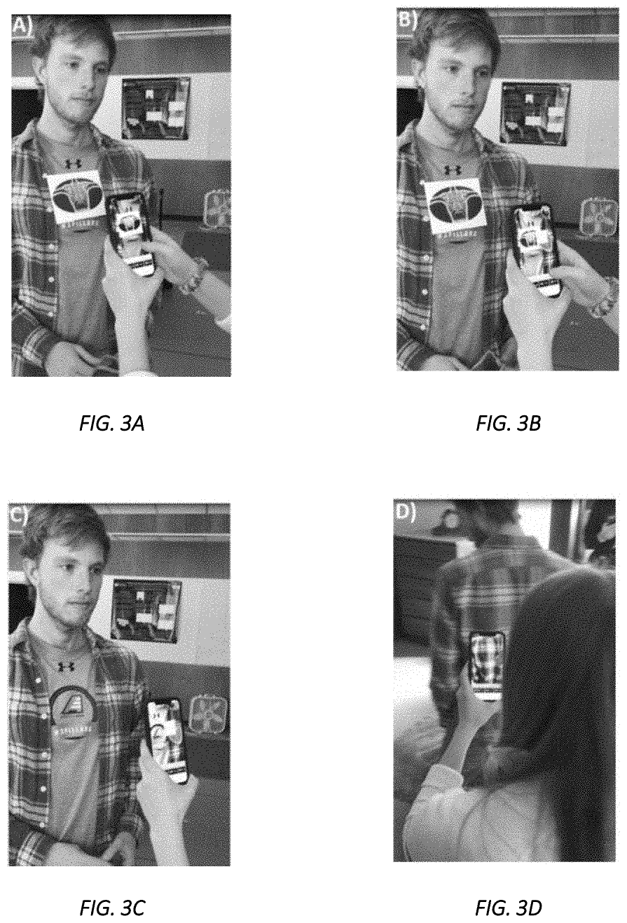

An example of this marker and the display of an AR heart onto (or in a location relative to) the marker is shown in FIGS. 3A-3D. FIGS. 3A and 3B illustrate steps of registering a marker. In FIG. 3B, the AR animation is displayed and in FIG. 3C, the AR animation remains after the marker is removed. In FIG. 3D, the AR animation spatially tracks even after the marker is removed and the target is repositioned with respect to the camera/display.

FIGS. 3A-3D, illustrate that the disclosed technology can be used to register a specific marker (the specificity of can be designated by uploading an image of the said marker into the suite of files uploaded while downloading and importing the lessons onto the device). Next, once the marker is recognized, the display of an AR figure can be triggered, where it can be ‘locked in’ the spatial mapping, allowing the marker to be removed. FIG. 3D serves as an excellent example for how versatile student movement can be once the AR display is locked in, allowing for three dimensional movements and travel away from and back to the patient actor without deducting from the accuracy of AR display.

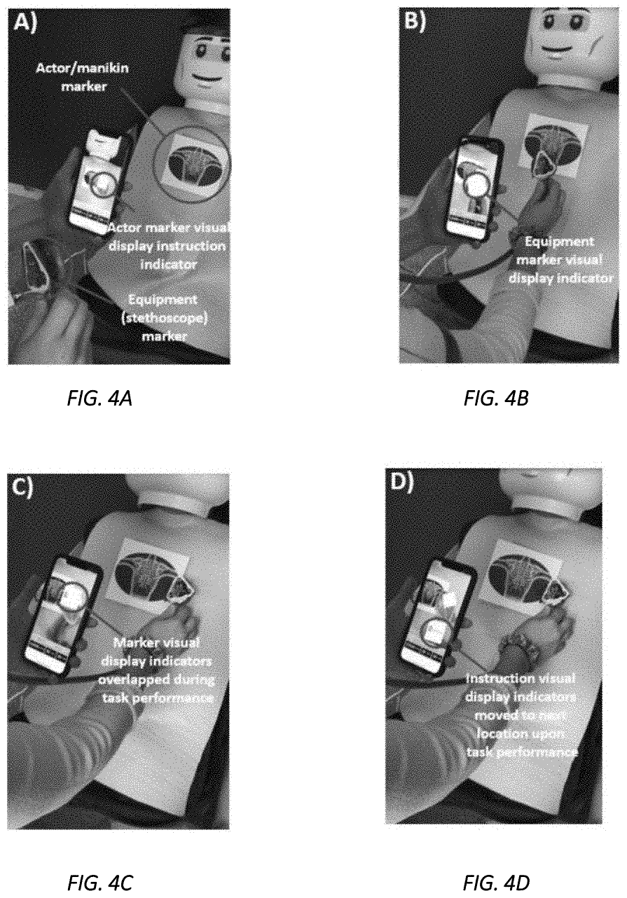

Next, techniques were employed to allow a student to interact with a patient, by, for example, performing a physical diagnostic or intervening measure and receiving feedback from the app on task performance. To do this, an additional marker tracking system was used in which a separate marker (or set of markers) were designated as (in this prototype's example) medical equipment. FIGS. 4A-4D illustrate how this method was performed.

As shown in FIGS. 4A-4D, a visual indicator (the UMAINE black bear logo) was fastened to a stethoscope and used as a marker. The software application was configured to recognize the marker and its location could then be registered in real-time relative to the location of the initial marker (on the actor). Next, an ‘action area’ was created, which is a set of coordinates spanning a certain three-dimensional space that corresponds to the location in which a task should be performed. For example, the action area for placing a stethoscope for respiratory assessment might be located on the surface of the chest, over a specific lobe. Using this action area, a criterion could be set for registering performance of a task in highly specific XYZ coordinates, allowing the software to communicate proper performance of a spatially-specific task (basically all physical tasks in a simulation scenario) by using information derived from these action areas starting simply with ‘correct placement’ to ‘time to respond’ measurements.

Using action areas, a software application was created that could recognize and differentiate between correct/incorrect performance of physical tasks, and use these cases as triggers to prompt both feedback, which can be presented to the user in the previously described text box window, or the next task, which can be presented via AR instruction and can be described in further detail in the text box window. The template for the operation of this app was compiled into JSON files, which are specific to actor/manikin markers, medical equipment markers, and lessons (which consist of a sequence of events connected by triggers, in which each event includes variable displays in each described HUD window).

### Computing Platform(s)

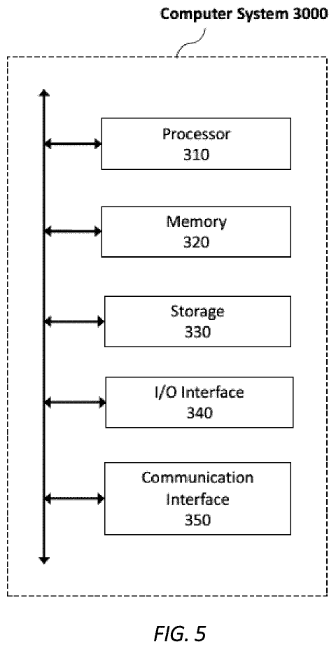

FIG. 5 shows an example computer system 3000 that may be used in some embodiments to perform some or all steps of the disclosed methods. This disclosure contemplates any suitable number of computer systems 3000. In some embodiments, computer system 3000 includes a processor 310, memory 320, storage 330, an input/output (I/O) interface 340, and/or a communication interface 350. In particular embodiments, processor 310 includes hardware for executing instructions, such as those making up a computer program. As an example and not by way of limitation, to execute instructions, processor 310 may retrieve (or fetch) instructions from an internal register, an internal cache, memory 320, or storage 330; decode and execute the instructions; and then write one or more results to an internal register, an internal cache, memory 320, or storage 330. In particular embodiments, processor 310 may include one or more internal caches for data, instructions, and/or addresses.

In particular embodiments, memory 320 includes main memory for storing instructions for processor 310 to execute or data for processor 310 to operate on. As an example and not by way of limitation, computer system 3000 may load instructions from storage 330 or another source (such as, for example, another computer system 3000, source 300, or retailer module 400) to memory 320. Processor 310 may then load the instructions from memory 320 to an internal register or internal cache. To execute the instructions, processor 310 may retrieve the instructions from the internal register or internal cache and decode the instructions. During or after execution of the instructions, processor 310 may write one or more results (which may be intermediate or final results) to the internal register or internal cache. Processor 310 may then write one or more of those results to memory 320. One or more memory buses (which may each include an address bus and a data bus) may couple processor 310 to memory 320. If present, a bus may include one or more memory buses. In particular embodiments, one or more memory management units (MMUs) reside between processor 310 and memory 320 to facilitate accesses to memory 320 requested by processor 310. In particular embodiments, memory 320 includes random access memory (RAM). This RAM may be volatile memory, when appropriate. In some circumstances, when appropriate, this RAM may be dynamic RAM (DRAM) or static RAM (SRAM). In some embodiments, memory 320 may encompass one or more storage media and may, generally, provide a place to store computer code (e.g., software or firmware) and data that is used by a computing platform (for example, platform 200). By way of example, memory 320 may, in some embodiments, include various tangible computer-readable storage media including Read-Only Memory (ROM) or Random-Access Memory (RAM).

In particular embodiments, storage 330 includes mass storage for data or instructions. As an example and not by way of limitation, storage 330 may include an HDD, a floppy disk drive, flash memory, an optical disc, a magneto-optical disc, magnetic tape, or a Universal Serial Bus (USB) drive or a combination of two or more of these. When appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, interface 340 includes hardware, software, or both providing one or more interfaces for communication between computer system 3000 and one or more I/O devices (for example, computing device 100). Computer system 3000 may include one or more of these I/O devices, when appropriate. One or more of these I/O devices may enable communication between a user and computer system 3000. When appropriate, I/O interface 340 may include one or more device or software drivers enabling processor 310 to drive one or more of these I/O devices. I/O interface 340 may include one or more I/O interfaces 340, when appropriate.

In particular embodiments, communication interface 350 includes hardware, software, or both providing one or more interfaces for communication (such as, for example, packet-based communication) between computer system 3000 and one or more other computer systems 3000 or one or more networks. As an example and not by way of limitation, communication interface 350 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 350 for it.

As will be understood, in some cases a specific performance device, as opposed to a general purpose computer, may be employed to perform the disclosed methods. Furthermore, in some example embodiments, the disclosed systems include one or more computer-readable non-transitory storage media embodying software that is operable when executed to perform any of the disclosed methods. The disclosed methods and systems, may, in some example embodiments, improve the employed hardware and/or software.

### Possible Applications/Uses

It will be appreciated that the disclosed methods and techniques can be utilized in various contexts. For example, the methods may prove useful in telemedical applications, in which a patient is diagnosed virtually. In some such embodiments, for example, a parent may utilize a mobile application to obtain a diagnosis for a sick child remotely by providing diagnostic prompts as specifically ordered tasks. The parent's motions can be tracked using the application and the tracked motions and observed or input patient symptoms can be automatically assessed with the software to inform subsequent tasks/diagnostic prompts to ultimately arrive at a diagnosis. If desired, the video feed may be updated to a network or cloud computing platform, where it may be accessed by a medical professional who may either participate in the interaction while it is ongoing or review the interaction to confirm the diagnosis.

Also, in a broader sense, the disclosed technologies and methods could be applied to any situation in which an interaction occurs on an object extension of an individual. Some examples include, but are not limited to, a boxer or martial artist training and hitting mitts or pads that a human is wearing. In some such embodiments, the augmented reality indicators may be displayed on the mitts and/or pads for the user to interact with and move on to the next instruction(s). These drills may be designed for speed and muscle memory training.

Another possible application for the presently disclosed technology is football pads worn by a training partner, wherein the user training can be directed toward optimal hand placement on the opponent based on opponent trajectory. This can lead to optimizing blocking technique, without directly touching the individual.

The features and advantages described herein are not all-inclusive and, in particular, many additional features and advantages will be apparent to one of ordinary skill in the art. Moreover, it should be noted that the language used in the specification has been selected principally for readability and instructional purposes, and not to limit the scope of the inventive subject matter described herein. The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

What is claimed is:

1. A method for completing a series of tasks using graphic indicators generated by a machine, the method comprising:
capturing a live video of a tangible target;
displaying the live video of the tangible target;
generating one or more graphic indicators specific to a first task, wherein the first task is directed to moving a tangible object in a predetermined way relative to a first location of the tangible target;
displaying the one or more generated graphic indicators on the live video of the tangible target;
detecting a position of the tangible object relative to the first location using the live video captured;
determining whether the detected position of the tangible object completes the first task;
generating one or more graphic indicators specific to a second task, after the first task has been determined to be complete, wherein the second task is directed to moving the tangible object in a predetermined way relative to a second location of the tangible target; and
displaying the one or more generated graphic indicators specific to the second task on the live video of the tangible target.

2. The method of claim 1, wherein determining whether the detected position of the tangible object relative to the first location completes the first task is accomplished using a processor and an algorithm stored in a memory device in communication with the processor.

3. The method of claim 1, wherein the one or more generated graphic indicators specific to the first task are displayed on or near the first location of the tangible target.

4. The method of claim 3, wherein the one or more generated graphic indicators specific to the second task are displayed on or near the second location of the tangible target.

5. The method of claim 1 further comprising continuing to display the one or more generated graphic indicators specific to the first task on the live video of the tangible target until the first task is determined to be complete.

6. The method of claim 1, wherein the position of the tangible object relative to the first location and the second location is detected using a camera.

7. The method of claim 6, wherein the camera is within a mobile computing device and a screen of the mobile computing device displays the live video of the tangible target.

8. The method of claim 1, wherein the one or more graphic indicators specific to the first task are displayed in a constant relative position to the first location of the tangible target.

9. The method of claim 8, wherein the one or more graphic indicators specific to the second task are displayed in a constant relative position to the second location of the tangible target.

10. The method of claim 1, wherein the one or more graphic indicators specific to the first task are distinct from the one or more graphic indicators specific to the second task.

11. The method of claim 1, wherein the tangible target is alive.

12. The method of claim 1, wherein the tangible target in inanimate.

13. The method of claim 1, wherein the tangible object is a human user or a device operated by a human user.

14. The method of claim 1, wherein the live video of the tangible target is displayed on a mobile computing device.

15. The method of claim 1, wherein the live video of the tangible target is displayed on a heads-up display.

16. The method of claim 1, further comprising:
generating one or more graphic indicators specific to a third task, after the second task has been determined to be complete, wherein the third task is directed to moving the tangible object in a predetermined way relative to a third location of the tangible target; and
displaying the one or more generated graphic indicators specific to the third task on the live video of the tangible target.
